(19) United States
(12) Patent Application Publication
(10) Pub. No.: US 2007/0012397 A1
(43) Pub. Date: Jan. 18, 2007

(54) Method and apparatus for a layered fabric

(75) Inventor: Ronald de Jong, Encinitas, CA (US)

Correspondence Address: BUCHANAN, INGERSOLL & ROONEY LLP, P.O. BOX 1404, ALEXANDRIA, VA, 22313-1404, US

(73) Assignee: Waterskinz, Inc., Carson City, NV (US)

(21) Appl. No.: 11/486,785

(22) Filed: Jul. 14, 2006

Related U.S. Application Data
(60) Provisional application No. 60/699,567, filed on Jul. 14, 2005.

(51) Int. Cl. B32B 37/00

(52) U.S. Cl. 156/252; 428/304.4

(57) ABSTRACT

The disclosure relates to multi-layered fabric for clothing and protective wear. More particularly it relates to a multilayer fabric providing improved insulation to the body of the wearer from the temperature differential in the environment in which the fabric is worn.

### CROSS REFERENCE TO RELATED APPLICATIONS

This application claims priority under 35 U.S.C. §119 to U.S. Provisional Application Ser. No. 60/699,567, filed Jul. 14, 2005, the disclosure of which is incorporated herein by reference in its entirety.

### TECHNICAL FIELD

The invention relates to multi-layered fabric for clothing and protective wear. More particularly it relates to a multilayer fabric providing improved insulation to the body of the wearer from the temperature differential in the environment in which the fabric is worn.

### BACKGROUND

In recent years, advances have been made in the development of new fabrics, including both synthetic fabrics and blends of natural and synthetic fabrics either alone or in combination with other materials sewn or applied to them to provide outer shell garments and the like to keep out cold and water. A wide variety of natural and synthetic fabrics are known in the prior art for constructing sportswear, rugged outerwear, protective clothing, etc. (for example, gloves, aprons, chaps, pants, boots, gators, shirts, jackets, coats, socks, shoes, undergarments, vests, waders, hats, gauntlets, etc.). Typically, vestments designed for use as rugged outerwear have been constructed of relatively loosely-woven fabrics made from natural and/or synthetic fibers (for example, cotton, polyesters, polyacrylics, polypropylene, etc.). While such materials can have a variety of beneficial properties, for example, dyeability, breathability, lightness, comfort, and in some instances, abrasion-resistance, such materials are easily worn out losing insulation. Commonly used materials include neoprene and polyurethane based garments. However, such materials, although useful, do not stretch and wear properly.

Thus, there exists a continuing unmet need for a fabric with the equal or better insulation capabilities as neoprene or polyurethane based garments used for thermal insulation of the wearer, especially for wetsuits and aquatic clothing. Such a product should possess superior thickness and stretchability characteristics. Such a fabric should provide excellent thermal insulation to the wearer with minimal discomfort, thickness, bulging, or weight. Further, such a product should breathe to allow moisture vapor to transpire when the wearer is out of the water.

More recently, advances have been made in the use of adhesive securement of fabrics that can, in some instances provide a substitute for sewing. These adhesives include thermoplastic adhesives that are heat actuated which are capable of bonding with fabrics to form a tight chemical as well as physical bond. These thermoplastic adhesives are available in a number of forms, including as a film, web, powder, print, spray, and aerosol.

### SUMMARY

The invention provides a laminated fabric comprising a first layer comprised of a shell fabric layer of woven or knitted fabric; a second layer comprised of a cell foam laminated to the opposite side of the second layer from the first layer; a third layer comprising a lining fabric of woven or knitted fabric laminated to the opposite side of the second layer from the first layer thereby placing the cell foam in a sandwiched position in between the first layer and the third layer; and the sandwiched position providing tensile strength to the cell foam, whereby a three layer fabric is achieved.

The invention also provides a laminated fabric comprising a first layer comprising a shell fabric layer of woven or knitted fabric; a second layer comprised of a film laminated to one side of first layer; a third layer comprised of a cell foam laminated to the opposite side of the second layer from first layer; a fourth layer comprising a woven or knitted fabric laminated to the opposite side of the third layer from the second layer thereby placing the cell foam in a sandwiched position in between the second layer and the fourth layer; and the sandwiched position providing tensile strength to the cell foam, whereby a four layer fabric is achieved.

The invention further provides a method of manufacturing a laminated fabric of the invention. The method comprises laminating one surface of a first layer of a shell fabric layer of woven or knitted fabric to a side surface of a second layer comprising a film; laminating a side surface of a third layer comprised of a cell foam laminated to an opposite side of the second layer from the shell layer; and laminating a side surface of a fourth layer of woven or knitted fabric laminated to an opposite side of the third layer from the second layer to thereby placing the third layer in a sandwiched position in between the second layer and the fourth layer and thereby reinforcing a tensile strength of the third layer.

The invention provides a method of manufacturing a laminated fabric of the invention comprising laminating one side surface of a first layer comprising shell fabric layer of woven or knitted fabric to a side surface of a second layer comprised of a cell foam; and laminating a side surface of a third layer of woven or knitted fabric laminated to an opposite side of the second layer from the first layer to thereby place the second layer in a sandwiched position in between the first layer and the third layer thereby reinforcing a tensile strength of the second layer.

The invention also provides a garment made from the laminated fabric of invention. In one aspect the garment is a wet-suit.

The details of one or more embodiments of the disclosure are set forth in the accompanying drawings and the description below. Other features, objects, and advantages will be apparent from the description and drawings, and from the claims.

### DESCRIPTION OF DRAWINGS

FIG. 1 shows a side view of the various layers of one embodiment of the invention forming the laminated fabric herein disclosed. Depicted are a first shell fabric layer 20, and optional second, film layer 30, a third, foam layer 40, and a fourth, lining layer 50. The lining layer can be treated or not treated to absorb liquid, pulling it off the body (including excess heat). Moisture vapor can transpires through a perforated foam and film (when present) to the shell fabric where it evaporates when exposed to the air. Comfort can be achieved through lighter weight composite, removal of moisture vapor and heat.

### DETAILED DESCRIPTION

As used herein and in the appended claims, the singular forms “a,” “and,” and “the” include plural referents unless the context clearly dictates otherwise. Thus, for example, reference to “a film” includes a plurality of such films and reference to “the composite” includes reference to one or more composites known to those skilled in the art, and so forth.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

Any publication in the text is provided solely for their disclosure prior to the filing date of the present application. Nothing herein is to be construed as an admission that the inventors are not entitled to antedate such disclosure by virtue of prior disclosure.

Clothing with a thermal insulating layer have been used in a water environment including in wetsuits, gloves, caps, and the like. These clothes are manufactured from laminated fabrics such as neoprene laminated to a shell layer.

Current wetsuits are typically manufactured from neoprene, a man-made rubber that is uncomfortable, heavy and restrictive. Despite surfing's explosive growth and that of other water sports, particularly among women, the basic wetsuit design has not changed in fifty years. Current designs are severely limited by the bulky neoprene material which offers little in visual variation or design capability.

Such wetsuits and other neoprene-based clothing provide thermal insulation by holding a thin layer of water next to your skin where your body can warm it. To work best, a wetsuit should not have empty bulges or folds that will suck in chilly pockets of water when you swim, nor should it be so tight that it restricts breathing or motion. Thus, any fabric laminated to the neoprene must have excellent stretch and contraction capabilities and not be prone to bulging.

Neoprene-based fabrics also provide some padding against knocks and falls and provide the benefit of additional buoyancy to the wearer when in the water. However, neoprene is essentially a rubber sponge when it comes to insulation. It can vary widely in quality depending on the manufacturer and method of manufacture. The internal bubbles which provide the insulating factor for the laminated end fabric in less expensive neoprene will collapse sooner in use, reducing the insulation value. Further, thicker neoprene suits which provide more insulation in colder environments tend to inhibit freedom of movement in proportion to the thickness of the neoprene.

Fuzzy rubber is a general term for a newer generation of fabrics with rubber-like polyurethane outer surfaces and fleece inner faces. Because they stretch in all directions, fuzzy rubber garments can be cut to fit close without impeding movement. These pieces can be worn on their own in warmer conditions or layered with other paddling wear when the air or water are colder.

Debate continues about whether fuzzy rubber on its own provides as much warmth as neoprene of equal thickness should the user be water immersed or in a particularly cold environment. However, since fuzzy rubber garments are usually more comfortable than neoprene based garments, they are widely used.

The multi-layered fabric (e.g., multi-laminate fabric) of the invention in its various embodiments provides an excellent material for the construction of wetsuits which provide improved water repellence and heat retention for the wearer. The disclosed fabric herein is not limited to clothing for the water environment but can also be used for garments intended for cold weather environments in the form of jackets, pants, hoods, gloves and the like. Further, the fabric may be employed for any type of clothing for any type of intended environment where an improved lightweight thermal insulating fabric is desirable for the wearer. It can also be used in sleeping bags, tents, laminate fabric sheets and the like.

Accordingly, the invention provides a multi-layered fabric material, comprising at least three layers of material. A further aspect of the invention is to provide a multi-layer composite fabric/laminate material for use in the manufacture of laminate fabric sheets, tents, sleeping bags, and outerwear.

A laminate, laminated structure or laminated fabric system of the invention, in the context of this disclosure and the claims that follow, is defined as a structure having multiple, discreet layers arranged in a co-planar, coextensive orientation and interconnected at least periodically if not continuously such that the layers acting in concert through their laminate layer interfaces have a unified functionality, with performance characteristics distinguishable from that of the individual layers acting alone. Interconnections between coextensive layers of a laminated structure, whether periodic or continuous, refers to means by which one layer is adhered to another. This includes the presence within the laminate structure of a discrete layer of adhesive, whether introduced by disposing an adhesive coating on one layer or by disposing a discrete intermediate layer or sheet of adhesive material within the pre-laminated stack of layers. The adhesive layer may be a continuous coating or sheet, or may occur in a periodic pattern having less than the full surface area of the laminate structure.

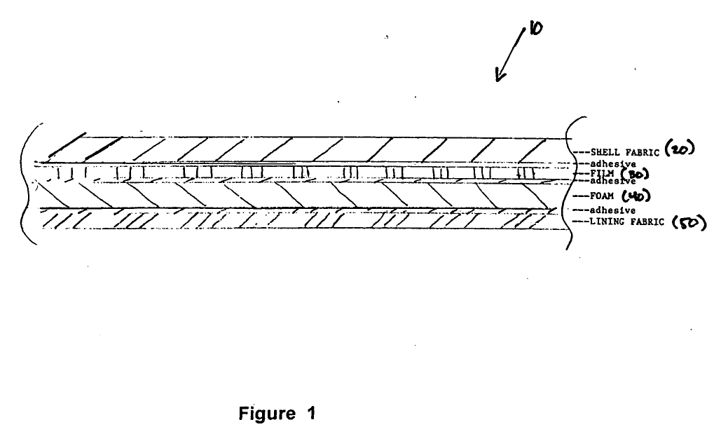

The multi-layered fabric disclosed and described herein achieves the above-mentioned goals through the provision of a multi-layered laminate fabric. Referring to FIG. 1, an embodiment of a multi-layered fabric 10 comprises a shell layer 20 which is formed from any type of woven, knit, or nonwoven fabric with sufficient or desired elastic or stretch characteristics. For example, the shell layer 20 can comprise a knit, woven or nonwoven, nylon, polyester, cotton and the like material. The shell layer 20 is laminated by either solvent, water based, web, powder or other techniques to a layer of film 30 which can be, for example, an olefin, polyurethane, rubber based, polyvinyl chloride, polytetrafluoroethylene or other film in breathable or non-breathable form. The film layer 30 is in turn laminated again through the aforementioned techniques to a cell foam layer 40. The cell foam layer 40 can be made of either closed or open cell foam such as Eliotex™, including urethane, olefin, pvc and the like materials. The cell foam layer 40 is in turn, using the aforementioned methods, laminated to a lining fabric layer 50 that is intended for contact with the skin of the wearer. For example, the lining layer 50 can comprise a knit, woven or nonwoven, nylon, polyester, cotton and the like material. While an open cell foam can be employed typically a closed cell foam is used.

Weights of any of the above have no bearing on the end product besides adding weight to the swim wear. In one aspect of the three layer fabric the film layer 30 is eliminated, yet still achieves water repellence and heat retention in the resulting laminated product. In a four layer laminate the film layer 30 is included. For the film layer 30, a breathable film allows moisture vapor to transpire when out of the water. Because closed cell foam products are not breathable, it has been found through experimentation that perforating the closed cell foam is desirable when breathability is required such as in a wetsuit. Consequently, perforated foam can be used in the invention; however, regular film and non-perforated foam would still yield an improved fabric, but one that would may not be as comfortable.

In one particularly embodiment of the fabric, the different layers consist of a nylon knit shell fabric, a non-breathable or breathable film, a closed cell foam which is perforated, and a nylon knit lining to render the fabric comfortable to the skin is provided. Additionally, if the lining fabric worn next to the skin of the wearer is treated to allow increased absorbency, it will pull water molecules off the body and through the composite thereby yielding extra comfort.

In another aspect, the shell layer may be water repellent. Water repellance of the yarn used in the shell fabric will enhance the ability of the fabric to remain light and comfortable yet still yield a fabric with enhanced strength provided by the scrim of the shell fabric.

The invention provides an improved thermal insulating fabric with superior thermal properties in a thinner fabric. The invention also provides a fabric which provides superior flotation provided by a closed cell foam layer but is still breathable through the provision of perforations of that layer. The invention further provides a better performing, more comfortable fabric for wetsuits and water worn clothing with superior thermal properties, flotation properties, and a thinner more comfortable fit.

Also provided by the invention is a method of making a fabric comprising at least 3 layers having improved durability and/or insulation. As one step a shell fabric which is formed from any type of woven, knit or nonwoven fabric having the desired elastic or stretch characteristics is laminated to an option film layer. Lamination is accomplished using either solvent, water based, web, powder or other techniques to a layer of film. In another aspect, the film is formed of one or more of a plurality of film materials including olefin, polyurethane, rubber based, polyvinyl chloride, polytetrafluoroethylene or other film. If the final garment is intended to breathe, then a breathable film is employed and conversely if the final fabric is not breathable a non-breathable film is employed.

Once the film and shell layers are properly laminated, the film layer is in turn laminated again using the aforementioned laminating materials to a closed cell foam thereby sandwiching the film layer between the shell layer and the closed cell layer. In another aspect, wherein the film layer is not present, the shell layer is laminated directly to the foam layer. Most such closed cell foams while having superior insulation and floatation qualities lack tensile strength. Laminating the closed cell foam to the film which is in turn laminated to the shell or by laminating the shell layer directly to the foam layer provides missing tensile strength to the closed cell foam most of which are easily torn.

Once the above two or three layers (depending upon the embodiment) are in their laminated engagement, the closed cell foam layer is in turn laminated to a lining fabric layer that is intended for contact with the skin of the wearer. This effectively places the closed cell foam in a sandwiched arrangement in between the lining and the shell or shell and film fabrics, thereby proving a means to increase the tensile strength of the closed cell foam through adhesion to both surfaces of the closed cell foam with a reinforcing fabric. This sandwiched arrangement allows the use of the relatively fragile closed cell foam while still yielding the tensile strength to resist tearing and the exterior scuff resistance to thereby resist damage to the closed cell foam when in use in such demanding sports as surfing. In this arrangement the superior floatation and thermal insulating properties of closed cell foam are employable in the finished product and overcome the fragile nature of the closed cell foam layer.

As noted, for the closed cell foam layer, where breathability is desired of the final multi-layer laminate fabric, the closed cell foam is perforated to provide this effect. If the film layer is employed, the film too would be chosen from a category of film that is breathable, or it too would be perforated when engaged with the foam layer to allow for a breathable final product. Perforation can be performed as a separate step when needed and in the correct order and may require the closed cell foam to first be laminated to the film layer or shell layer with the other layer(s) thereafter engaged to sandwich the two now breathable engaged layers in between.

The shell layer and/or lining fabric of the invention can comprise a number of blend fabrics useful for applications involving articles of apparel utilized for outerwear and sporting wear, in which improved resistance to water, thermo-insulation, and/or strength (e.g., cut, tear, rip resistance) is desired over typical articles of apparel for such purposes known in the prior art. An “intimate blend fabric” as used herein refers to a fabric including therein at least two different types of fibers, and in some instances a plurality of different types of fibers, wherein the different types of fibers are each present in a single layer of the fabric.

The term “fiber” as used herein refers to an elongate, individual and essentially monolithic unit of matter, either natural or synthetic, that forms the basic element of a fabric. The term “filament” as used herein refers to a fiber of an indefinite or extreme length. The term “staple fiber” as used herein refers to fibers having a shorter length (less than about 40 inches and typically betwden about 1 inch and about 4 inches), such fibers either normally having such a length (e.g. many natural fibers) or being cut or stretch broken from filaments. A “fiber bundle” as used herein refers to a plurality of fibers and/or filaments grouped together to form a multi-fiber strand bundle. A “yarn” as used herein refers to any continuous strand of fibers or filaments in a form suitable for knitting, weaving, or otherwise intertwining to form a textile fabric including, but not limited to: a number of fibers twisted together into a single fiber bundle (single ply spun yarn); a number of filaments laid together without twist (a zero-twist yarn); a number of filaments laid together with a degree of twist; a single filament with or without twist (a monofilament yarn); and two or more fiber bundles twisted together (a plied yarn or multi-ply yarn). A “woven fabric” as used herein refers to a fabric characterized by intersecting warp and fill yarns interlaced so that they cross each other at essentially right angles, the term including, but not limited to, well known woven structures such as plain weave (including variations thereof such as basket weaves), twill weaves, and satin weaves.

The multi-laminated fabric of the invention comprises layers that are stacked and/or bonded into multiple layer structures, and/or can be layered/laminated with other fabric or non-fabric layers, for example a water impermeable, breathable film layer (e.g., permeable to water vapor but substantially impermeable to liquid water). The inventive fabrics can also be coated with a variety of high or low modulus polymeric coatings to increase puncture, cut, and/or tear resistance.

The term “breathable” as used herein refers to a membrane or other layer that is permeable to gases, such as air and water vapor, but essentially impermeable to aqueous liquids, such as water. Such breathable barrier materials enable the laminate fabric of the invention to be rendered water resistant or essentially “water proof,” while allowing good breathability via the permeation of air through the material and/or the escape of water vapor from a wearer via evaporation from the body and permeation through the layer of barrier material. Monolithic membranes that are formed of polymeric materials that have high rates of diffusion for water vapor but do not require cast-in pores are useful for the film layer. Polymeric materials of urethane, acrylic latexes or other films are suitable for this type of monolithic membrane. These films can be blown, extruded, cast separately and then laminated to one or more layers. These monolithic films may also be coated or cast directly onto the shell layer or foam layer. The thinner and softer films of this type are most desirable as they have the highest rate of vapor transport and are the most comfortable to a wearer.

In some embodiments, breathable film layer comprises a porous membrane, such as a microporous or monolithic membrane. The term “microporous membrane” or “microporous layer membrane” as used herein refers to a specific layer of a multi-layer fabric of the invention, which includes a plurality of pores having a size sufficient to prevent the passage of liquid water there through, while, at the same time, permitting diffusion and/or convection of water vapor, at substantially ambient temperatures and pressures. The particular pore size necessary for the microporous membrane to function as a water vapor-permeable, liquid water-resistant layer will, as understood by those skilled in the art, depend on the material characteristics and surface properties of the material comprising the microporous membrane. Typically, the microporous membrane is formed from a hydrophobic polymeric material. In some illustrative embodiments, pores of the microporous membrane can fall within a size range of from about 0.1 micron to about 100 microns.

In some embodiments, a microporous or monolithic membrane layer comprises a coating adhered to at least a portion of a surface of shell layer or foam layer. The area of interlayer adhesion may be restricted in a periodic manner or pattern of discontinuous attachment that assures a significant number and uniform distribution of the micropores of a microporous layer remain open and unaffected by the attachment adhesive in the areas of attachment. In one embodiment, the microporous or monolithic membrane layer comprises an adhesive, it is typical that the adhesive comprises a polymeric material having a modulus of elasticity of about 5,000 to 100,000 psi. A partial list of suitable polymeric film materials for forming microporous membranes includes, but is not limited to, urethane polymers, acrylic latex polymers, butyl, latex, silicone, and neoprene rubbers, polyolefins, polyvinylchloride, polysulfone, and the like. For embodiments involving a microporous film layer comprising an adhesive material, the film is formed on surface of the shell or foam layer by depositing a solution containing dissolved polymeric material for forming the microporous film onto the surface of the shell or foam layer, followed by allowing the solution to harden to form microporous film layer by solvent evaporation. In such embodiments, the rate of solvent evaporation can be controlled so as to form the above-mentioned plurality of micropores in the film in order to render the film substantially impermeable to liquid water but readily permeable to water vapor. Methods for forming microporous polymeric film layers via controlled solvent evaporation of a cast polymeric solution are known in the art and described in a variety of standard references related to the subject. The particular parameters for use in forming a microporous film layer having desired properties for a given polymeric material are readily determinable in light of this disclosure using no more than routine experimentation and optimization and a variety of routine and straight forwarding screening tests involving the casting of films of polymer solutions of varying thicknesses in a variety of solvents for the polymer followed by solvent evaporation at various controlled rates with subsequent testing of the resultant porous film layers for liquid water resistance and water vapor permeability. The polymer solution for forming a microporous film layer is disposed on a surface of the shell or foam layer at a thickness corresponding to a specific weight of the microporous film layer of no greater than about 0.25 to 1 ounce per square yard.

For embodiments wherein the microporous or monolithic film layer is attached to shell layer, the film layer can be attached to surface of the shell layer by a variety of means, as would be apparent to those of ordinary skill in the art, including, but not limited to, thermal bonding or attachment via a continuous or discontinuous layer of an adhesive. For embodiments where microporous or monolithic film layer is attached to the shell layer via an adhesive material and the adhesive is not permeable to water vapor and atmospheric gases, the adhesive will typically be applied in a discontinuous fashion, such as would form a periodic or repeating pattern of attachment, allowing sufficient surface area of contact between the film layer and the shell layer to be essentially free of adhesive so as to permit permeation of water vapor and other gases. Alternatively, the adhesive material may be formed of a polymeric material or materials, which are permeable to water vapor. In some embodiments, the adhesive can comprise a material including, but not limited to, polyurethanes, acrylic polymers, and poly(vinyl chloride). For embodiments where a microporous film layer comprises a separable layer (i.e. not a coating) overlaid with or attached and laminated to a shell layer, it is typical that microporous film layer comprise a hydrophobic membrane. In some embodiments, such hydrophobic membrane can be comprised of materials including, but not limited to, poly(tetrafluoroethylene) (PTFE—e.g., TEFLON™ or expanded PTFE, e.g., GORETEX™), polyolefins, polyurethanes, foamed neoprene rubber, etc. Films and adhesives comprising the above-mentioned materials having properties and pore sizes rendering them permeable to water vapor but substantially impermeable to liquid water are well-known in the art, and are readily commercially available.

Referring, again, to FIG. 1 a four-layer laminate fabric is shown and illustrated. In one aspect, the laminate fabric 10 comprises shell layer 20 and microporous or monolithic film layer 30, as previously described, a foam layer 40 and further includes a lining layer 50, which is coextensive and interconnected at least periodically. The foam layer 40 is attached on the opposite surface of the film layer 30 from the shell layer 20. The foam layer 40 can be attached to the film layer 30 (or in the absence of the film layer 30 to the shell layer 20) by a variety of means, as would be apparent to those of ordinary skill in the art, including, but not limited to, thermal bonding or attachment via a continuous or discontinuous layer of an adhesive. The lining layer 50 serves as an inner layer adjacent to the wearer's body (i.e., configured as a liner). The lining layer 50 is constructed/selected to have one or more desirable properties, such as, for example, dyeability and printability, softness, smoothness, quietness, abrasion resistance, and the like. In some preferred embodiments, liners/shell layer 102 comprises and preferably consists essentially of a plurality of fibers formed of one or more materials including, but not limited to, polyamides (e.g. nylon), cellulosic materials (e.g., cotton), polyesters, acrylic polymers, and polyolefins.

For efficiency in manufacture the multi-layered fabric laminate material is fabricated using adhesive material applied over the surface of adjoining layers of fabric in a manner to cause adhesion of the adjoining layers over only those selected portions of the surface areas thereof that are in communication with one another and to which adhesive material has been applied, and further so as to cause adjoining layers of fabric in other than these selected portions to remain non-adhered, but integrally a part of the laminate. The adhesive material used may be applied continuously or discontinuously to a surface to be bonded.

The adhesive material is preferably a thermoplastic adhesive material that is heat actuated and is adapted to be applied in a number of ways, including, but not limited to, as a film, as a powder, as a print, as a web, and as an aerosol spray deposition.

As is used herein, the term facing surface refers generally to either side of a piece of fabric. As is well known to those of ordinary skill in the art, a piece of fabric has what is known as a front and a back. The front and the back of any piece of fabric may have the same or different finishes, which may, for example, be smooth or textured. The terms front and back refer to the front and back of a sheet of fabric as it is made on the knitting machine, and do not necessarily correspond to a front and back, respectively, of the fabric as it is incorporated in a fabric laminate according to the invention. Where only one side of the piece of fabric is smooth, and the other is textured, the smooth side is generally referred to as the front (which may or may not be the same as the front of the fabric as it is made on the knitting machine) and the textured side is generally referred to as the back (which may or may not be the same as the back of the fabric as it is made on the knitting machine). In a fabric with a smooth face, the fabric may have a gloss or sheen on that side. In a fabric with a relatively rough or textured back, the fabric may have a dull or “porous” appearance on that side. Where one side of the piece of fabric has a design or pattern therein, or has a bright or colored surface, while the other side is matte, plain, monotone, or uncolored, the former side is generally referred to as the front and the latter as the back.

In a fabric laminate according to the invention, the laminate may be formed such that either the front or the back of one layer of the fabric is adhered to either the front or the back of the other layer of fabric, depending on a number of considerations, including utilitarian considerations regarding which two sides of the fabric layers are most compatible from the perspective of being glued together, as well as from comfort and aesthetic considerations.

It is also to be understood that in the construction of a fabric laminate according to the invention, there are certain facing surfaces of the individual fabric layers that make up the fabric laminate that will be internal or interior to the fabric laminate and certain facing surfaces of the individual fabric layers that make up the fabric laminate that will be external or exterior to the final fabric laminate. Internal or interior facing surfaces face inwardly into the interior of the fabric laminate and external or exterior facing surfaces face outwardly away from the interior of and to the exterior of the fabric laminate. All fabric laminates have at least three external or exterior facing surfaces and at least three internal or interior facing surfaces. Thus, for example, a three layer fabric laminate has three external or exterior facing surfaces and three internal or interior facing surfaces (one facing surface of each fabric layer faces outward and one faces inward).

Also as used herein the terms single-piece and single main piece, referring to garments fabricated according to the invention, means garments wherein the body or main portion of the garment is made from what is substantially one piece of fabric laminate, wherein the fabric laminate is itself, however, made from multiple layers of fabrics that may be the same or different, and/or wherein even individual fabric layers may be made from composites of different fabrics that are abuttingly adhered to one another to form a single contiguous piece of laminate fabric.

The thermoplastic adhesive is applied between the two layers of fabric before they are placed together. The dry thermoplastic adhesive may be applied to what will become an inner surface of one of the fabric layers as a dry powder, as a spray, or as a web. The second piece of fabric, typically of about the same dimensions as the first piece, is then placed on top of the first piece of fabric and the adhesive. Prior to placement of the second fabric layer of fabric and/or prior to application of the adhesive, any other inserts, such as a gore or other reinforcing and stabilizing side panels, and/or a channel and reinforcing/shaping wire, are also inserted. After the multi-layer “sandwich” of two fabric layers, together with any inserts and the adhesive, has been formed, it is ready for heat treatment to actuate the adhesive and seal the layers and inserted materials together over at least those portions that have been exposed to adhesive, to form the fabric laminate.

The multi-layer fabric laminates of three or more layers are made by the same general process as described above, with the further provision that the adhesive is applied between each and every adjoining fabric layer over whatever portions of the contacting surfaces of the layers it is desired to achieve permanent adhesive contact when the adhesive material is actuated.

This process can be automated to a continuous or semi-continuous basis wherein a plurality of laminate fabric sheets can be made sequentially from a roll of fabric laminate, and even wherein the roll of fabric laminate is itself made on a continuous basis from a plurality of rolls of material, with there being a individual roll for each layer of the fabric laminate, and even for the adhesive material where it is in the form of a web of the adhesive material.

The hot-melt process involves the formation of both chemical and physical bonds between the adhesive material and the layers of fabric, due to a combination of temperature and pressure effects, but does not so restrict or bind up the fabric and interstitial spacing or “pores” in the fabrics to significantly impair air permeability or stretch characteristics.

The hot-melt process is typically carried out in several stages, including a “heating” stage and a “cooling” stage. The temperature at which the heating stage is conducted must be at least at or slightly above the melt temperature of the adhesive material being used. For most adhesive materials, the melt-temperature and temperature of the heating stage is in the range of from about 100° C. to about 200° C. This is well below temperatures, which would damage or otherwise affect the physical characteristics of the fabric used in the multi-layer laminate. The second, or cooling stage of the hot-melt process is conducted at a lower temperature to cause the adhesive material, which is still in a molten or semi-molten state exiting from the heating stage, to be rapidly cooled so that it sets and forms chemical bonds and physical bonds with the fabric layers and other inserted reinforcing and/or channel materials, thereby causing all layers and pieces of the laminate to adhere to one another.

The heating stage of the hot-melt process is conducted at pressures that are sufficient to cause the molten adhesive to spread and bond with the fabric layers with which it is in contact, without penetrating or bleeding through the fabric, while chemically bonding with the fabric layers. The cooling stage of the hot-melt process is conducted at a pressure sufficient to keep the elements of the laminate tightly bound together until the adhesive cures and seals all of the layers and pieces together.

In the high temperature step, the assembled laminate fabric sheet is exposed to heat that raises the temperature of the laminate fabric sheet to at or just above the melting point temperature of the adhesive in the adhesive web, causing the web to melt and the adhesive to flow into the pores or interstices of the fabric layers and/or over those portions of the fabric itself, which have been exposed to and are in contact with the adhesive. By controlling the nature and flow properties of the adhesive used, as well as the temperature of the heat treatment process steps themselves, the adhesive can be controlled so that only those portions of the fabric laminate and any inserted pieces in the laminate fabric sheet that are desired to be glued together are in fact glued together, and those portions that are not to be glued, if any, in a laminate fabric sheet for a given garment wherein it is desired that not all portions of the laminate fabric sheet are to be glued together are left glue-free during and after heat treatment.

The hot stage of the hot-melt process is immediately followed by a cold stage of the hot melt process, wherein the temperature of the fabric laminate is rapidly lowered so as to cause the molten adhesive to re-solidify and bond the various layers and pieces of the fabric laminate together. As the molten adhesive cools and solidifies, it forms both chemical and physical bonds with the fabric material and with the material of the other inserted pieces in the laminate. Typically, the temperature of the cold stage of the hot-melt process is in the range of from about 50° C. to about 150° C. The cold stage is also performed under pressure to maintain good contact between all of the glued layers and inserted pieces of the laminate as the adhesive sets in order to form a strongly bonded laminate with no gaps or entrapped air bubbles between any of the layers that would destroy the integrity and aesthetic appearance of the fabric laminate. The residence or dwell time of the fabric laminate in the cold stage of the hot-melt process is typically of the same order of magnitude as in the hot stage, with a minimum of about 10 seconds and a maximum of about 90 seconds.

Generally, the dwell time for each of the heating and cooling stages should be on the order of from about at least about 10 seconds, up to a maximum time of about 90 seconds. Typically, the dwell time in each stage is about equal. Determination of the individual stage and total dwell times is a matter of optimization that depends on the natures of the fabric layers and other materials and the nature of the adhesive material. Such determinations can readily be made by persons of ordinary skill in the art.

After the fabric laminate has been formed from the individual layers of fabric material(s), any intermediate stabilizing, reinforcing, and/or channel materials, and the adhesive material, in the hot-melt process, the fabric laminate is allowed to cool and is then ready for the production of laminate fabric sheets therefrom, from which individual garments are made. The laminate fabric sheets are then cut out using die cutting or other suitable means.

The several sections of the fabric laminates are then laid out such that the different sections of the final garment are adjacent to one another. The garment is then assembled by first applying an adhesive material along juxtaposed sections and activating the adhesive to cause the several layers to adhere to one another. At the juncture of the first and second sections, as well as any other sections of the garment, the joining lines can further be glued or spot-welded on the exterior surfaces of the garment to produce a more complete and more aesthetic joint between adjacent sections of the garment.

Assembly of the layers and pieces of the laminate fabric sheet can also be done as a manual operation, or assembly on a batch basis can be automated, with machines laying the layers down in sequence and placing the inserted pieces in position as required. Where such a batch laminate fabric sheet assembly procedure is automated, a computer control is typically used and a line-up and tracking procedure for the laminate fabric sheets to ensure that the layers and pieces are assembled within a predetermined tolerance. For example, an optical scanning system can be incorporated to help in doing this. In such a system, each layer or piece of the laminate fabric sheet to be assembled has some indicia present thereon to enable an optical scanning device to determine that the layers and pieces have been positioned properly With respect to one another. Such indicia may be permanent or may be temporary. Typically any such indicia printed on any of the layers or parts be placed where they will not be visible in a finished garment. Where it may be unavoidable that such indicia can be seen, they can be printed with temporary inks that will evaporate from the surface before the final garment is finished from the laminate fabric sheet.

When the laminate fabric sheet is fully assembled, with all of the layers and pieces in position, it is ready for heat treatment, using a hot-melt process. The assembled laminate fabric sheets are sent to a heat treatment step wherein the thermoplastic adhesive (e.g., adhesive web) is thermally actuated in a hot-melt process to cause all layers and parts of the assembled laminate fabric sheet that are in contact with the adhesive material of the web to become glued together when the adhesive web melts and the adhesive is actuated or made tacky.

The technique of “bridging” abutting different fabrics of an individual layer and adjacent different fabrics of different layers is, however, relatively easy and utilizes an adaptation of the technique of inserting various stability, control, and shape providing materials in the fabric laminates of the invention as previously described. The “bridging” technique involves the insertion of bridging pieces of material between layers of the composite fabric laminate at all coinciding “seam” lines of abutting different fabrics wherever adjacent layers of the composite fabric laminate are themselves made from different fabrics and at least one of the adjacent layers is not itself made from one continuous piece of a single fabric. Notwithstanding that the adhesive used to adhere the abutting different fabrics and adjacent different fabric layers of a composite fabric laminate according to the invention may be in the form of a pre-cut laminate fabric sheet of a thermoplastic adhesive resin web material, which spans all of the abutting different fabrics and adjacent different fabric layers when the composite fabric laminate sheet is assembled for heat treatment to adhere the various fabrics and layers, the adhesive web laminate fabric sheet and the adhesive material contained therein, even after the web melts to supply the molten adhesive, which in turns cools and sets to glue the various fabrics and layers together, generally does not itself provide sufficient lateral backing or support for the composite fabric laminate in any of its web, molten, or set states, thereby necessitating the insertion of the “bridging” material pieces.

The material used for the bridging pieces generally should not itself have a high elasticity, and, in any case, should have a lower modulus of elasticity than the fabrics that are being bridged. Typical materials used for the bridging pieces include cotton, nylon and polyester. The bridging material insert pieces can alternatively be partial or continuous over the entire length of a joint or “seam” line between different abutting fabrics. Where they are not continuous, generally a plurality of pieces are used at predetermined intervals over the length of a joint line.

A number of embodiments of the invention have been described. Nevertheless, it will be understood that various modifications may be made without departing from the spirit and scope of the invention. Accordingly, other embodiments are within the scope of the following claims.

What is claimed is:

1. A laminated fabric comprising:
a first layer comprised of a shell fabric layer of woven or knitted fabric;
a second layer comprised of a cell foam laminated to the opposite side of the second layer from the first layer;
a third layer comprising a lining fabric of woven or knitted fabric laminated to the opposite side of the second layer from the first layer thereby placing the cell foam in a sandwiched position in between the first layer and the third layer; and
the sandwiched position providing tensile strength to the cell foam, whereby a three layer fabric is achieved.

2. The laminated fabric of claim 1, further comprising a film layer laminated to one side of the first layer, between the first layer and the second layer, wherein the film layer comprises a water impermeable material.

3. The laminated fabric of claim 2, wherein the water impermeable material is a breathable water impermeable material.

4. The laminated fabric of claim 2, wherein the water impermeable material is perforated.

5. The laminated fabric of claim 1, wherein the cell foam is a closed cell foam.

6. The laminated fabric of claim 5, wherein the closed cell foam is perforated.

7. The laminated fabric of claim 1, wherein the cell foam is an open cell foam.

8. The laminated fabric of claim 1, wherein the first, second and third layers are adhered together.

9. A laminated fabric comprising:
a first layer comprising a shell fabric layer of woven or knitted fabric;
a second layer comprised of a film laminated to one side of first layer;
a third layer comprised of a cell foam laminated to the opposite side of the second layer from first layer;
a fourth layer comprising a woven or knitted fabric laminated to the opposite side of the third layer from the second layer thereby placing the cell foam in a sandwiched position in between the second layer and the fourth layer; and
the sandwiched position providing tensile strength to the cell foam, whereby a four layer fabric is achieved.

10. The laminated fabric of claim 9, wherein the cell foam is a closed cell foam.

11. The laminated fabric of claim 10, wherein the closed cell foam is perforated.

12. The laminated fabric of claim 9, wherein the cell foam is an open cell foam.

13. The laminated fabric of claim 11, wherein the perforated closed cell foam and the film is breathable to thereby yield a breathable fabric.

14. The laminated fabric of claim 9, wherein the film layer comprises a water impermeable, breathable membrane selected from the group of membranes consisting of microporous and monolithic membranes.

15. The laminated fabric of claim 9, wherein the second layer comprises an adhesive coating attached to at least one of the first and third layer.

16. The laminated fabric of claim 15, wherein the adhesive coating is formed of a material selected from the group consisting of: urethane adhesives and acrylic latex adhesives.

17. The laminated fabric of claim 9, wherein the film comprises a hydrophobic polymeric material.

18. The laminated fabric of claim 9, wherein the second layer is attached to the first layer by an adhesive.

19. The laminated fabric of claim 18, wherein the adhesive comprises a material selected from the group consisting of: polyurethanes; acrylic polymers; and poly(vinyl chloride).

20. The laminated fabric of claim 9, wherein the layers are attached by thermal bonding.

21. The laminated fabric of claim 9, wherein the second layer comprises a hydrophobic membrane.

22. The laminated fabric of claim 21, wherein the hydrophobic membrane is formed from a material selected from the group consisting of: poly(tetrafluoroethylene); polyolefins; and polyurethanes.

23. The laminated fabric of claim 9, wherein the cell foam is a foamed neoprene rubber.

24. A method of manufacturing a fabric comprising:
laminating one surface of a first layer of a shell fabric layer of woven or knitted fabric to a side surface of a second layer comprising a film;
laminating a side surface of a third layer comprised of a cell foam laminated to an opposite side of the second layer from the shell layer; and
laminating a side surface of a fourth layer of woven or knitted fabric laminated to an opposite side of the third layer from the second layer to thereby placing the third layer in a sandwiched position in between the second layer and the fourth layer and thereby reinforcing a tensile strength of the third layer.

25. A method of manufacturing a fabric comprising:
laminating one side surface of a first layer comprising shell fabric layer of woven or knitted fabric to a side surface of a second layer comprised of a cell foam; and
laminating a side surface of a third layer of woven or knitted fabric laminated to an opposite side of the second layer from the first layer to thereby place the second layer in a sandwiched position in between the first layer and the third layer thereby reinforcing a tensile strength of the second layer.

26. The method of claim 24 or 25, further comprising perforating the cell foam layer.

27. The method of claim 24, further comprising perforating the second, film layer.

28. A garment made from the laminated fabric of claim 1 or 9.

29. The garment of claim 28, wherein the garment is a wetsuit.
